(19) United States
(12) Patent Application Publication
(10) Pub. No.: US 2007/0177630 A1
(43) Pub. Date: Aug. 2, 2007

(54) Apparatus, method and computer program product providing retransmission utilizing multiple ARQ mechanisms

(75) Inventors: Jukka Ranta, Kaarina (FI); Tsuyoshi Kashima, Yokohama (JP); Esa Malkamaki, Espoo (FI); Jussi Tapani Kahtava, Tokyo-to (JP); Kimmo Kettunen, Espoo (FI); Vinh Van Phan, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/606,855

(22) Filed: Nov. 29, 2006

Related U.S. Application Data
(60) Provisional application No. 60/741,143, filed on Nov. 30, 2005.

(51) Int. Cl. H04J 3/24

(52) U.S. Cl. 370/473; 370/428; 714/748

(57) ABSTRACT

A method includes receiving at least one transport block and determining from the at least one transport block a first data unit, wherein a portion but not all of the first, data unit includes a second data unit; determining information corresponding to acknowledgement status of the first data unit; determining, based at least on the information, whether a request should be performed requesting retransmission of the second data unit; and performing the request in response to a determination the request should be performed. Another method includes determining information corresponding to acknowledgement status of a previously transmitted data unit, wherein a portion but not all of the previously transmitted data unit includes a second data unit; determining, based at least on the information, whether retransmission of the second data unit should occur; and performing the retransmission of the second data unit in response to a determination the retransmission should be performed.

### CROSS-REFERENCE TO RELATED APPLICATIONS

The present application claims the benefit under 35 U.S.C. §119(e) of U.S. Provisional Patent Application No. 60/741,143, filed on 30 Nov. 2005, the disclosure of which is hereby incorporated by reference in its entirety.

### TECHNICAL FIELD

The exemplary and non-limiting embodiments of this invention relate generally to wireless communications systems and, more specifically, relate to techniques that provide for a retransmission of data.

### BACKGROUND

The following abbreviations that appear herein are defined as follows:

3GPP third generation partnership project

ACK acknowledged (a positive acknowledgement)

AM acknowledged mode

ARQ automatic repeat request

BTS base transceiver system

CRC cyclic redundancy code

DL downlink

HARQ hybrid automatic repeat request

HSDPA high speed downlink packet access

MAC medium access control

MIMO multiple input multiple output

NACK not acknowledged (a negative acknowledgement)

PDU protocol data unit

PHY physical

PSN packet sequence number

RLC radio link control

RNC radio network controller

SDU service data unit

TB transport block

TSN transmission sequence number

UE user equipment

UL uplink

WCDMA wideband code division multiple access

UMTS universal mobile telecommunications system

L1 layer 1 (physical layer)

L2 layer 2 (medium access control layer)

HSDPA is a packet-based data service feature of the WCDMA standard that provides a data transmission of up to 8-10 Mbps (and 20 Mbps for MIMO systems) over a 5 MHz bandwidth in the WCDMA DL. The high speed of HSDPA is achieved through techniques including: 16 Quadrature Amplitude Modulation, HARQ with variable error coding and incremental redundancy. HSDPA may be considered to be a technology upgrade to current UMTS networks.

HARQ combines an ARQ principle—a method of controlling errors in which a receiver detects error(s) in a received data unit and automatically requests a retransmission from the transmitter—and forward error correction over the radio connection. The forward error correction is used to determine whether or not an automatic request for a retransmission should be performed. Typically, if the errors are correctable, no request is performed, whereas if the errors are not correctable, a request is performed. Then, residual link-level packet errors after HARQ operation can further be recovered by using a link-layer ARQ protocol operating above HARQ.

Although these techniques are beneficial, there are still problems associated with implementations of these techniques.

### BRIEF SUMMARY

In an exemplary embodiment, a method is disclosed that includes receiving over a wireless link at least one transport block and determining from the at least one transport block a first data unit, wherein a portion but not all of the first data unit includes a second data unit. The method includes determining information corresponding to acknowledgement status of the first data unit and determining, based at least on the information, whether a request should be performed requesting retransmission of the second data unit. The method additionally includes performing the request in response to a determination that the request should be performed.

In another exemplary embodiment, an apparatus is disclosed that includes a first receiver configured to receive over a wireless link at least one transport block. The first receiver is configured to determine from the at least one transport block a first data unit, wherein a portion but not all of the first data unit includes a second data unit. The apparatus also includes a second receiver coupled to the first receiver. The second receiver is configured to determine, based at least on the information, whether a request should be performed requesting retransmission of the second data unit. The second receiver is further configured to perform the request in response to a determination that the request should be performed.

In a further exemplary embodiment, a computer program product is disclosed that tangibly embodies a program of machine-readable instructions executable by a digital processing apparatus to perform operations. The operations include receiving over a wireless link at least one transport block and determining from the at least one transport block a first data unit, wherein a portion but not all of the first data unit includes a second data unit. The operations also include determining information corresponding to acknowledgement status of the first data unit and determining, based at least on the information, whether a request should be performed requesting retransmission of the second data unit. The operations further include performing the request in response to a determination that the request should be performed.

In another exemplary embodiment, a method is disclosed that includes determining information corresponding to acknowledgement status of a previously transmitted data unit that was transmitted over a wireless link using a transport block, wherein a portion but not all of the previously transmitted data unit includes a second data unit. The method includes determining, based at least on the information, whether retransmission of the second data unit should occur. The method also includes performing the retransmission of the second data unit in response to a determination that the retransmission should be performed.

In an additional exemplary embodiment, an apparatus is disclosed that includes a first transmitter configured to determine information corresponding to acknowledgement status of a previously transmitted data unit that was transmitted over a wireless link using a transport block, wherein a portion but not all of the previously transmitted data unit includes a second data unit. The apparatus also includes a second transmitter coupled to the first transmitter. The second transmitter is configured to determine, based at least on the information, whether retransmission of the second data unit should occur. The second transmitter is additionally configured to perform the retransmission of the second data unit in response to a determination that the retransmission should be performed.

In an exemplary embodiment, a computer program product is disclosed that tangibly embodies a program of machine-readable instructions executable by a digital processing apparatus to perform operations. The operations include determining information corresponding to acknowledgement status of a previously transmitted data unit that was transmitted over a wireless link using a transport block, wherein a portion but not all of the previously transmitted data unit includes a second data unit. The operations also include determining, based at least on the information, whether retransmission of the second data unit should occur. The operations further include performing the retransmission of the second data unit in response to a determination that the retransmission should be performed.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 shows a simplified block diagram of various electronic devices that are suitable for use in practicing the exemplary embodiments of this invention;

FIG. 2 is a simplified block diagram of an embodiment of a system with both ARQ and HARQ, where ARQ is in a MAC (forming at least a part of L2), HARQ is in PHY (L1), and shows the L1/L2 interface between them;

FIG. 3 is a simplified block diagram of another embodiment of the system with both ARQ and HARQ, where ARQ is in RLC (a part of L2), HARQ controller/manager is in MAC (a part of L2), and shows the interface between them;

FIG. 4 illustrates through example of how SDUs from radio bearers are mapped onto transport blocks;

FIG. 5 is a communication diagram between a receiver and transmitter for implementing one exemplary embodiment of retransmission;

FIG. 6 is a flowchart of a method performed during transmission for providing retransmission using multiple ARQ mechanisms; and

FIG. 7 is a flowchart of a method performed during reception for providing retransmission using multiple ARQ mechanisms.

### DETAILED DESCRIPTION OF EXEMPLARY EMBODIMENTS

By way of introduction, in current standardization efforts, such as those for a proposed 3GPP UTRA and UTRAN long term evolution (LTE) network, it may be useful to employ HARQ. According to the experience in HSDPA, however, the use of only HARQ is not sufficient to efficiently achieve a packet error rate lower than 10⁻³. Therefore, the use of an additional ARQ mechanism on top of the HARQ is desirable. In general, the HARQ performs the main role in the error correction loop, and is supported by ARQ.

Assuming this HARQ/ARQ scenario, attention should be paid to the architecture of the ARQ mechanism so that the mechanism can efficiently utilize the information from the HARQ, including retransmission decision-making, signaling, and the interface between them.

More specifically, the use of the two (H)ARQ loops is desirable to achieve the desired level of reliability. The use of the double loops of HARQ and ARQ, however, adds complexity due to the double signaling over the air, signaling between ARQ and HARQ, and the inclusion of additional fields in PDUs to accommodate the operation of the two H(ARQ) loops.

In this context, then, the specification of an efficient ARQ scheme that supports and incorporates HARQ is thus desirable.

In the current HSDPA, there is no close collaboration between the HARQ and the ARQ. Instead, the HARQ was simply added to the existing WCDMA ARQ when HSDPA was introduced.

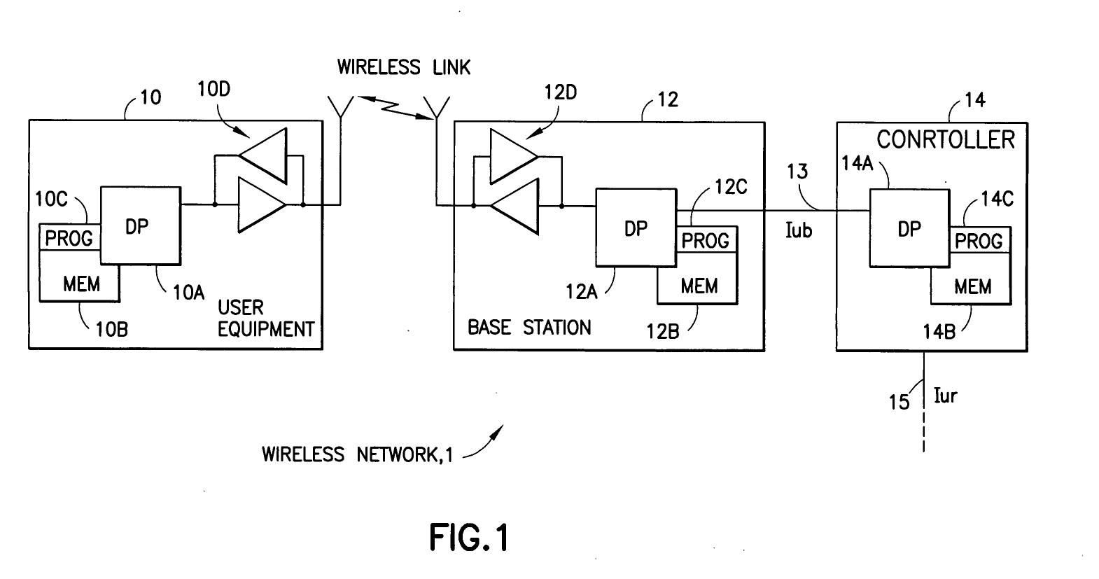

Reference is made first to FIG. 1 for illustrating a simplified block diagram of various electronic devices that are suitable for use in practicing the exemplary embodiments of this invention. In FIG. 1, a wireless network 1 is adapted for communication with a UE 10 via a base station (e.g., Node B or BTS) 12. The UE 10 is a digital processing apparatus. The network 1 may include a network controller (e.g., RNC) 14, which may be referred to as, e.g., a serving RNC (SRNC). The UE 10 includes a data processor (DP) 10A, a memory (MEM) 10B that stores a program (PROG) 10C, and a suitable radio frequency (RF) transceiver 10D for bidirectional wireless communications with the base station 12, which is a digital processing apparatus and also includes a DP 12A, a MEM 12B that stores a PROG 12C, and a suitable RF transceiver 12D. The base station 12 is coupled via a data path 13 (Iub) to the network controller 14 that also includes a DP 14A and a MEM 14B storing an associated PROG 14C. The network controller 14 may be coupled to another network controller (e.g., another RNC) (not shown) by another data path 15 (Iur). At least one of the PROGs 10C, 12C and 14C is assumed to include program instructions that, when executed by the associated DP, enable the electronic device to operate in accordance with the exemplary embodiments of this invention, as will be discussed below in greater detail.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and the other DPs, or by hardware, or by a combination of software and hardware.

The MEMs 10B, 12B, and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A, and 14A may be of any type suitable to the local technical environment, and may include one or more of general purpose computers, special purpose computers, microprocessors, digital signal processors (DSPs) and processors based on a multi-core processor architecture, as non-limiting examples.

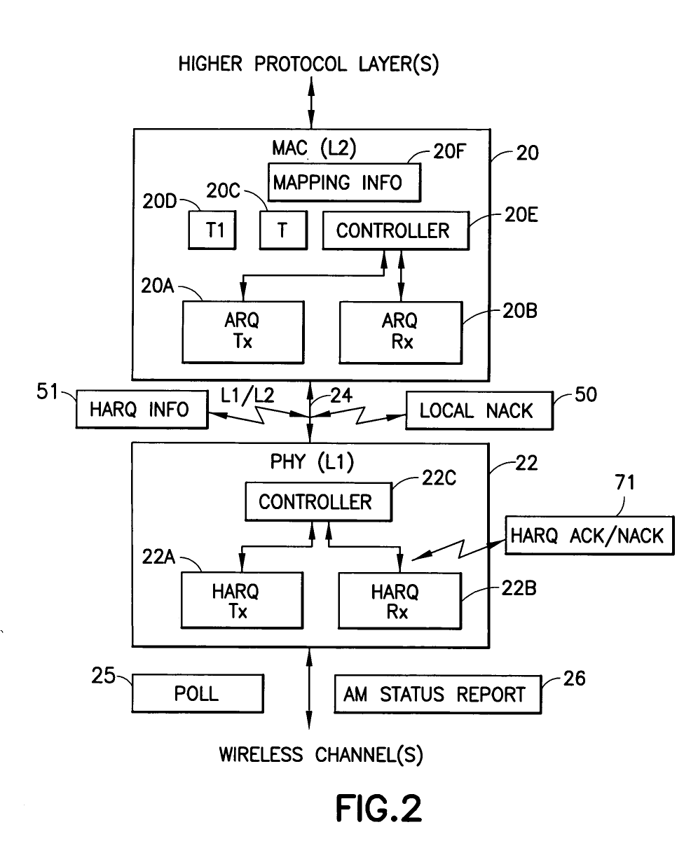

FIG. 2 is a simplified block diagram of a MAC 20 (including RLC as its sub-layer and together forming at least a part of L2), PHY 22 (L1), and shows the L1/L2 interface 24 between them. The L1 interfaces to the wireless channel(s), e.g., through a transceiver 10D, 12D. The MAC 20 (L2), PHY 22 (L1) may be embodied in the UE 10, in the base station 12, or in both. The MAC 20 (L2) is assumed to include for the purposes of an exemplary embodiment of this invention an ARQ transmitter (Tx) 20A and an ARQ receiver (Rx) 20B and a controller 20E, and the PHY 22 (L1) is assumed to include for an exemplary embodiment of this invention a HARQ transmitter (Tx) 22A, a HARQ receiver (Rx) 22B, and a controller 22C, which controls operations of the PHY 22 (L1). A timer (T) 20C is also assumed to be included in the MAC 20 (L2), as is a timer T1 20D. T 20C time-out is a part of L2 AM normal operation, whereas T1 20D expiring results in some L2 pro-active control and retransmission actions, as discussed below. The controller 20E of the MAC 20 controls operations of the MAC 20.

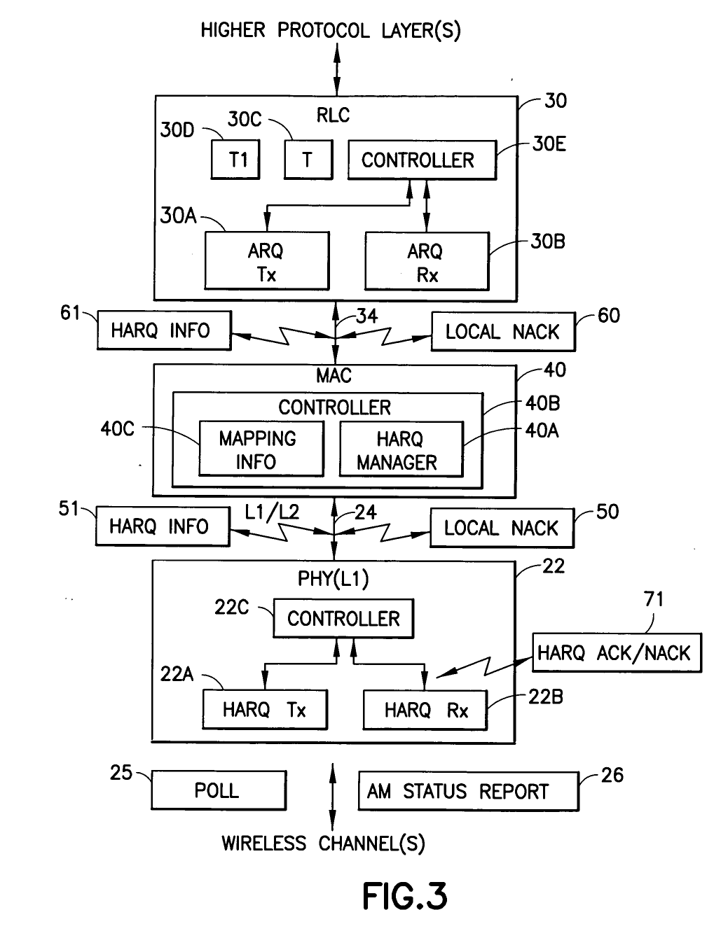

The MAC 20 also includes mapping information 20F, which is used to map from ARQ (e.g., L2) data units to HARQ (e.g., L1) data units, as described in more detail below. The aspects of the MAC 20 (L2), PHY 22 (L1) of particular interest herein may be embodied with computer program code (e.g., in PROG 10C, 12C), or in hardware, or in a combination of program code and hardware. The ARQ receiver 20B is assumed to be capable of generating and sending an AM status report 26 (e.g., ARQ ACK/NACK), for example, based on a request using polling (as illustrated by a poll message 26). One of the main triggers for a retransmission in ARQ operation is the negative acknowledgement (NACK) of particular RLC PDU sequence(s) sent in an AM status report 26. Polling (e.g., using poll message 25) is most often used by the ARQ transmitter (e.g., 20A or 30A shown in FIG. 3) to request a status report from a peer ARQ receiver (e.g., 20B or 30B shown in FIG. 3). Thus, an “AM status report” is a generic item of an ARQ protocol which also includes a retransmission request or more typically a negative acknowledgement (NACK) of missing ARQ PDU (e.g., RLC PDU) sequence(s). The AM status report 26 includes therefore an indication of acknowledgement status of one or more ARQ PDUs.

It is noted that the HARQ receiver 22B can communicate HARQ ACK/NACK information 71 with the HARQ transmitter 22A. Similarly, the ARQ receiver 20B can communicate acknowledgement status information, such as ACK/NACK information, with an ARQ transmitter 20A by using, e.g., the AM status report 26. The HARQ transmitter 22A can communicate with the ARQ transmitter 20A, and the HARQ receiver 22B can communicate with the ARQ receiver 20B. Such communication may take the form, for instance, of a “local NACK” 50, which indicates that a HARQ failure has occurred (and potentially other information as to which HARQ data unit the failure corresponds). In an exemplary embodiment, the local NACK 50 is not intended to be sent for each and every HARQ NACK. Instead the local NACK 50 indicates a failure of transmission attempts (including retransmissions) for a given transport block at HARQ level (e.g., PHY 22). This often means that HARQ level was trying to retransmit a given transport block several times up to a maximum allowed number and still was not able to transmit that transport block successfully. Then, the HARQ transmitter 22A may send a local NACK 50 to the ARQ level (e.g., ARQ transmitter 20A) at the transmitter side so that ARQ transmitter 20A may try to retransmit data, mapped on that given transport block, with new transport block(s) and the HARQ process may repeat for new transport block(s). The HARQ failure here is referred to, for example, when the number of HARQ retransmissions reaches a maximum allowed value for a given HARQ data unit (i.e., TB) or a HARQ level retransmission (ReTx) time-out and the HARQ is still not able to transmit the TB successfully (i.e., no ACK is received to that TB). The communication may also take other forms, e.g., of a generic HARQ information 51. It should be noted that the HARQ manager 40A shown in FIG. 3 is also in the MAC 40 in FIG. 2, although the HARQ manager 40 is not shown in FIG. 2.

FIG. 3 is a simplified block diagram of a MAC 40, RLC 30 architecture, and shows the interface 34 between them. The MAC 40 and RLC 30 in this example are part of L2. However, HARQ Tx 22A and HARQ Rx 22B are physically in L1 (PHY 22) but HARQ control functions and signaling, such as ACK/NACK and transport format selection, are terminated in MAC by the HARQ manager 40A. The interface 34 is where, in the example of FIG. 3, the actual HARQ-ARQ interaction occurs. The MAC 40 interfaces to lower protocol layer(s) (such as the PHY (L1) 22), while the RLC 30 interfaces to higher protocol layer(s). The MAC 40, RLC 30 may be embodied in the UE 10, in the base station 12, or in both. The MAC 40 is assumed to include for an exemplary embodiment of this invention a HARQ manager 40A, and the RLC 30 is assumed to include for the purposes of this exemplary embodiment an ARQ transmitter (Tx) 30A and an ARQ receiver (Rx) 30B. A timer (T) 30C is also assumed to be included in the RLC 30, as is a timer T1 30D. T 30C time-out is a part of L2 AM normal operation, whereas T1 30D expiring results in some pro-active control and retransmission actions, as discussed below.

The MAC 40 also includes a controller 40B, which controls operations of the MAC 40 and includes the HARQ manager 40A and mapping information 40C. The mapping information 40C is used to map from ARQ (e.g., L2) data units to HARQ (e.g., L1) data units, as described in more detail below. It is noted that the HARQ manager 40A and mapping information 40C could be separate from the controller 40B, if desired. It is also noted that the mapping information 40C could be included in the RLC 30 (e.g., as part of controller 30E) if desired. The aspects of the MAC 40 or RLC 30 of particular interest herein may be embodied with computer, program code (e.g., PROG 10C, 12C), or in hardware, or in a combination of program code and hardware. The ARQ receiver 30B is assumed to be capable of generating and sending an AM status report 26 (e.g., ARQ ACK/NACK), for example, based on a request using polling (as illustrated by a poll message 26).

It is noted that the HARQ receiver 22B can communicate ACK/NACK information 71 with the HARQ transmitter 22A. Similarly, the ARQ receiver 30B can communicate acknowledgement information with the ARQ transmitter 30A. The HARQ transmitter 22A can communicate with the ARQ transmitter 30A, and the HARQ receiver 22B can communicate with the ARQ receiver 30B via MAC. Such communication may take the form, for instance, of a “local NACK” 50, which may be communicated through MAC 40 as local NACK 60. The communication may also take the form, e.g., of a generic HARQ information message 51. It is noted that items 60 and/or 61 are typically a mapping of local NACK or other HARQ acknowledgement status onto relevant information of ARQ, such as sequences of RLC PDU(s) that are included in the failed transport block indicated by the local NACK.

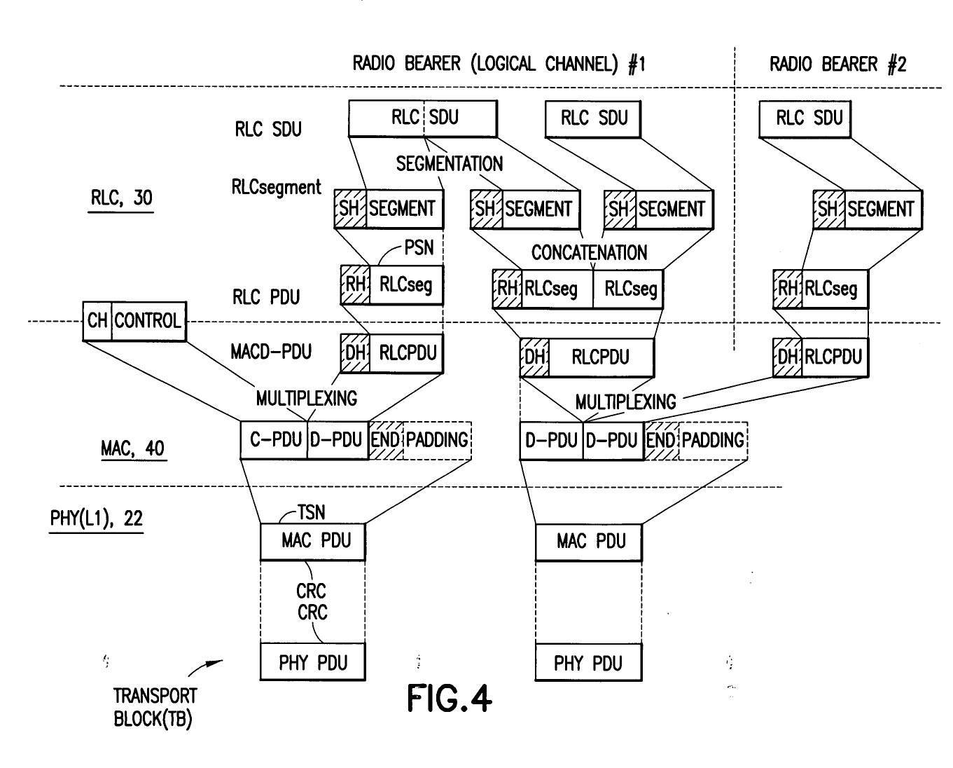

Before turning to a more detailed description of embodiments of the invention, it is helpful to review FIG. 4, which illustrates through example how SDUs from radio bearers are mapped onto transport blocks. In FIG. 4, the following abbreviations are used: SH=segment header; RH=RLC header; CH=C-PDU header (control-PDU); DH=D-PDU header (data-PDU); End=end of data, if needed; and Padding=padding, if needed. In FIG. 4, the RLC 30 and MAC 40 are L2 20 of FIG. 2, such that the L2 20 is split into the RLC 30 and MAC 40. The radio bearers (e.g., logical channels) 1 and 2 communicate RLC SDUs to the RLC 30. Through segmentation, these RLC SDUs are possibly separated into RLC segments. Through concatenation, the RLC segments might be combined into RLC PDUs, each of which contains a PSN. The RLC PDUs become MAC D-PDUs (e.g., SDUs) at MAC 40. The MAC 40 adds a TSN to each of the MAC D-PDUs. The MAC 40 creates MAC PDUs, which may or may not have CRCs. The PHY 22 uses the MAC PDUs to create PHY PDUs (e.g., a transport block (TB)), which have CRCs.

RLC PDUs are one example of an ARQ unit of information (called an “ARQ data unit” herein) that will be possibly segmented and combined with other units of information for placement into a HARQ unit of information (called a “HARQ data unit” herein), which is typically a MAC PDU. Some technique, such as a PSN and associated mapping (e.g., from TSN, HARQ process identity, or dispatching timestamp to PSN) is used so that the ARQ unit of information can be determined at the reception side from the HARQ unit(s) of information. Similarly, some technique, such as a TSN, HARQ process identity, or dispatching timestamp, is used such that the HARQ units of information can be determined at the reception side and mapped to ARQ unit(s) of information.

It is noted that a TSN is may be used in a MAC PDU to identify a transport block and/or used for reordering after HARQ operation as in HSDPA. However, a TSN may not be needed herein. This is because a transport block can be identified by other techniques such as its HARQ process identity (ID) and/or its dispatching time-stamp. The reordering can be performed on the RLC level based on PSN.

Turning now to a more detailed description of embodiments of the invention, the following assumptions may be made in one example (as implemented, e.g., by the system in FIG. 2). First, the L1 HARQ operates for the MAC PDU (in PHY PDU), and the L2 ARQ operates for RLC PDU (considering that RLC is a part of MAC). RLC PDU is made of RLC SDUs via segmentation and concatenation (see FIG. 4) by, e.g., MAC 20 in FIG. 2. Second, MAC (L2) 20 maintains (using, e.g., mapping information 20F) the mapping between the MAC PDU and RLC PDU (again considering that RLC is a part of MAC), by using, for example, the mapping between TSN (for MAC PDU, if the TSN is used) and PSN (for RLC PDU). Third, both L1 22 and L2 20 can identify a MAC PDU by using, for example, the TSN. Fourth, the L2 ARQ scheme is assumed by way of example to be polling and timer basis, as discussed in greater detail below. Fifth, the CRC is attached in L1 primarily for the purposes of the L1 HARQ. The use of a CRC for the L2 ARQ is optional. It should be noted in this regard that a fast retransmission mechanism, without the use of any L2 CRC overhead, is one non-limiting advantage of the use of exemplary embodiments of this invention. Sixth, the accuracy of the CRC error detection is superior to the error of a L1 NACK/ACK flipping error. The L1 NACK/ACK flipping error refers to a situation in the receiver in which a NACK is misunderstood as an ACK, or nothing received (DTX), or vice versa.

In another example, the following assumptions may be made (as implemented, e.g., by the system of FIG. 3). First, the HARQ operates for the MAC PDUs, and ARQ operates for the RLC PDUs. As shown above, RLC PDU is made of RLC SDUs via segmentation and concatenation (see FIG. 4). Second, RLC/MAC controller (e.g., 20E/40B) maintains (by using, e.g., the mapping information 40C, which could also be implemented in the RLC 30) the mapping between the MAC PDU and RLC PDUs, for example, by using the mapping between TSN (for MAC PDU) and PSN (for RLC PDU; see FIG. 4). Third, the ARQ scheme implemented by the RLC 30 is assumed by way of example to be polling and timer basis, as discussed in greater detail below. Fourth, the use of a CRC for ARQ (implemented in RLC 30) is optional. It should be noted in this regard that a fast retransmission mechanism, without the use of any CRC overhead specific to ARQ, is one non-limiting advantage of the use of exemplary embodiments of this invention.

Certain exemplary embodiments of this invention pertain to an ARQ transmitter process (e.g., performed by ARQ transmitters 20A/30A) and to an ARQ receiver process (e.g., performed by the ARQ receivers 20B/30B). The basic ARQ scheme (the items (a) and (b) below) are implemented for both the transmitter and receiver sides. The items ((c) and (d)) are provided as an enhancement of the ARQ scheme, and can be implemented at one or both of the transmitter and receiver sides.

(1) Transmitter Side

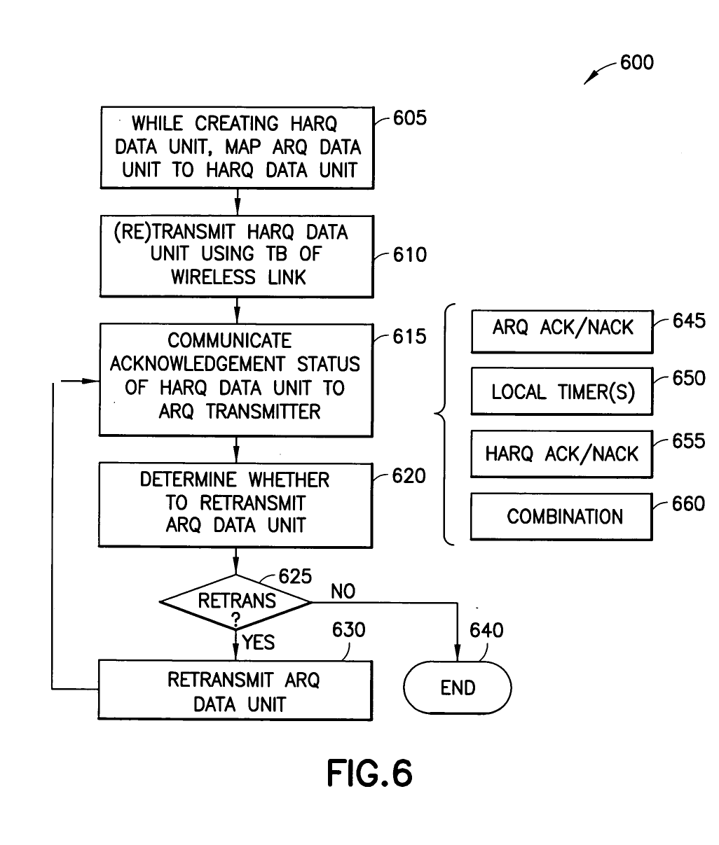

The following description explains in detail the procedures used in the transmitter side (either the UE 10 or the base station 12). The items (a) and (b) may be considered to be assumptions of the exemplary embodiments of this invention. Reference may also be had to FIG. 6, which is a flowchart of a method 600 performed during transmission for providing retransmission using multiple ARQ mechanisms. As previously described, while creating a HARQ data unit (e.g., MAC PDU), an ARQ data unit (e.g., RLC PDU) is mapped (e.g., by a controller 20E/40B used to control an ARQ transmitter 20A/30A) to the HARQ data unit. This occurs in block 605. Such mapping may be stored, e.g., in mapping information 20F/40C. In block 610, the HARQ data unit is transmitted over a wireless link using a transport block. It is noted that block 610 may also include one or more HARQ retransmissions of the HARQ data unit. In block 615, the HARQ transmitter 22A communicates acknowledgement status (see, e.g., blocks 645-660 and elements 50, 51, 60, 61) to the ARQ transmitter 20A/30A, as explained in more detail below. In block 620, the ARQ controller (e.g., 20E/30E) makes a determination as to whether the ARQ data unit should be retransmitted. This determination may use the techniques (a)-(d) below.

(a) The ARQ transmitter 20A/30A, also referred to as the L2 transmitter in AM using an ARQ scheme combined with polling, for example, makes a determination to retransmit based on ARQ ACK/NACK information from the ARQ receiver 20B/30B (block 645).

(b) The ARQ transmitter 20A/30A may determine to make the retransmission based on using local timer(s) 22 (T interval) that operate to guard the event of transmitting the requested data (block 650).

(c) The ARQ transmitter 20A/30A may determine to retransmit based on a HARQ (success)/failure indication (e.g., in HARQ information 51, 61 or in local NACK 50, 60) from HARQ transmitter 22A (e.g., and/or the HARQ manager 40A) (block 655).

(c.1) The HARQ transmitter 22A/40A indicates (block 615) HARQ (success)/failure indication (e.g., in HARQ information 51, 61 or local NACK 50, 60) (e.g., based on a HARQ ACK/NACK, timer and/or maximum allowed number of HARQ retransmissions per a transport block) to ARQ transmitter 20A/30A, via the L1/L2 interface 24 and interface 34, or a HARQ ACK/NACK lost indication that is received from the HARQ receiver 22B, or on a retransmission (ReTx) time-out indication, or an indication based on the number of HARQ retransmissions exceeding a maximum allowed value for a given ARQ data unit (e.g., a MAC PDU). A “HARQ ACK/NACK lost” is a DRX (discontinuous reception) that is nothing received instead of expected ACK/NACK at a particular time of HARQ operation. It is noted that these indications may be included in, e.g., HARQ information 51, 61 or local NACK 50, 60, although typically the local NACK 50, 60 is based on a maximum allowed number of HARQ retransmissions per a transport block.

(d) The ARQ transmitter 20A/30A may determine to make a retransmission based on combination of two or more of the cases discussed above (block 660).

(d.1) The ARQ transmitter 20A/30A sends a specific data sequence identified by the PSN and timed for some T interval, which is requested by the ARQ receiver 20B/30B.

(d.2) If the ARQ transmitter 20A/30A receives a HARQ failure indication from the HARQ transmitter 22A/40A, and neither an ARQ ACK/NACK nor a T timeout has occurred, the ARQ transmitter 20A/30A waits T1 interval (T1 is from the L2 timer 20D/30D guarding the HARQ operation for the data packet, T1<T) and during T1:

(d.2.1) If the ARQ transmitter 20A/30A receives an ARQ ACK/NACK, the ARQ transmitter 20A/30A follows (a);

(d.2.2) Else if the ARQ transmitter 20A/30A receives a T time-out, the ARQ transmitter 20A/30A follows (b);

(d.2.3) Else if the T1 timer 20D/30D expires, the ARQ transmitter 20A/30A (respectively) notifies the ARQ receiver 20B/30B (respectively) to reset the timer for the given ARQ (e.g., L2) segments (e.g., RLC segments or PDUs) and starts ARQ (e.g., L2) retransmission (block 630);

(d.3) Else if the ARQ transmitter 20A/30A receives an ARQ ACK/NACK and not a T timeout, the ARQ transmitter 20A/30A follows (a);

(d.4) Else, the ARQ transmitter 20A/30A follows (b).

It is noted, as described in (a)-(d), that when it is determined that an ARQ data unit should be retransmitted (block 625=YES), the ARQ data unit is retransmitted (block 630), typically by using both the ARQ transmitter 20A/30A and HARQ transmitter 22A. It is noted that an ARQ data unit will typically be packaged in a single HARQ data unit, but may be packaged in multiple HARQ data units. If there is no determination that a retransmission should be made (block 625=NO), method 600 ends in block 640.

The operations identified as (d.2.1)-(d.2.2) avoid an occurrence of an error of HARQ ACK/NACK detection at the transmitter side, whereas (d.2.3) proactively initiates an early ARQ (e.g., L2) retransmission in case the ARQ NACK is delayed. This beneficially reduces HARQ-ARQ (e.g., L1-L2) retransmission redundancy and delay.

The operation (d) is provided to avoid unnecessary ARQ (e.g., L2) retransmissions due to a NACK/ACK flipping error and exception cases of the previous operations. Upon receiving a HARQ failure, instead of an ARQ (e.g., L2) retransmitting immediately, the ARQ (e.g., L2) controller 20E/40B delays a maximum of T1 and during that period waits for a ARQ (e.g., L1) ACK to arrive so that the controller can make a better decision as to whether an actual retransmission is needed. Thus, the shorter (than T timer 20C/30C) T1 timer 20D/30D is provided to aid in eliminating some HARQ (e.g., L1) retransmission “false alarms”.

(2) Receiver Side

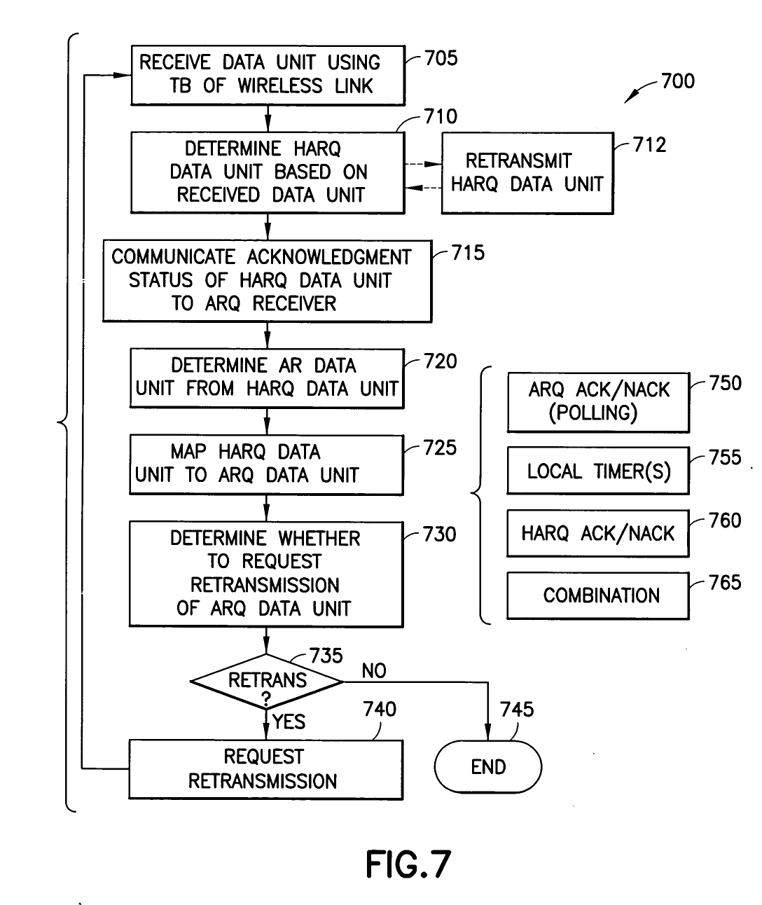

The following description explains in detail the procedures used in the receiver side (either the UE 10 or the base station 12). The items (a) and (b) may be considered to be assumptions of the exemplary embodiments of this invention. Reference may also be had to FIG. 7, which is a flowchart of a method 700 performed during reception for providing retransmission using multiple ARQ mechanisms. In block 705, a data unit (e.g., a PHY PDU) is received by, e.g., HARQ receiver 22B over a wireless link using a transport block. In block 710, a HARQ receiver (e.g., HARQ receiver 22B) determines a HARQ data unit (e.g., a MAC PDU) from the received data unit. It is noted that in block 712, the HARQ data unit could be retransmitted one or more times, based on HARQ techniques. In block 715, acknowledgement status (see, e.g., blocks 750-765 and elements 50, 51, 60, 61) of a HARQ data unit is communicated from the HARQ receiver to an ARQ receiver (e.g., ARQ receiver 20B/30B). In block 720, an ARQ data unit (e.g., RLC PDU) is determined (e.g., by the ARQ receiver 20B/30B) using the HARQ data unit. In block 725, the HARQ data unit is mapped to the ARQ data unit.

In block 730, it is determined whether to request retransmission of the ARQ data unit. Such determination may be made using, e.g., (a)-(d) below.

(a) The ARQ receiver 20B/30B, also referred to as an L2 receiver in AM using an ARQ scheme in the embodiment shown in FIG. 2, is capable of generating and sending a L2 AM status report 26 (ARQ ACK/NACK), for example, based on a request using polling (e.g., poll message 25) (block 750).

(b) The ARQ receiver 20B/30B of FIG. 2 is capable of generating and sending a L2 AM status report 26 based on the local timer(s) 20C/30C (T interval) that guard the event of receiving the expected data (block 755).

(c) The ARQ receiver 20B/30B of FIG. 2 is capable of generating and sending, e.g., a L2 AM status report 26 based on notification (block 715) from the HARQ receiver 22B. The generation and sending occurs in block 760. For FIG. 2, the HARQ receiver 22B communicates through the HARQ manager 40A to the ARQ receiver 30B.

(c.1) The HARQ receiver 22B notifies (block 715) an occurrence of a HARQ failure to the ARQ receiver 20B/30B based on, for example, a HARQ retransmission time-out or a number of retransmissions exceeding a maximum allowed number for a given MAC PDU received with a CRC error. It is noted that in FIG. 3, the HARQ receiver 22B can notify the ARQ receiver 30B through use of the HARQ manager 40A. This could be a “pass through”, such that the HARQ receiver 22B passes the occurrence of a HARQ failure through the HARQ manager 40A. As another example, the MARQ manager 40A could determine the HARQ failure from the HARQ receiver 22B and then communicate the HARQ failure to the ARQ receiver 30B.

(c.2) The ARQ receiver 20B/30B is capable of determining the corresponding PSN from the HARQ failure notification.

(d) The ARQ receiver 20B/30B is capable of generating and sending a L2 AM status report 26 (ARQ ACK/NACK) based on two or more of the cases discussed above (block 765).

(d.1) The ARQ receiver 20B/30B expects to receive a specific data sequence identified by the PSN and timed for T interval.

(d.2) If the ARQ receiver 20B/30B receives a HARQ failure notification from the HARQ receiver 22B during T, and not the expected data, the ARQ receiver 20B/30B generates and sends an ARQ (e.g., L2) NACK to the ARQ transmitter 20A/30A about the expected PSN.

(d.3) Else if the ARQ receiver 20B/30B receives a T timeout, but neither the expected data nor a HARQ failure notification from the HARQ receiver 22B, the ARQ receiver 20B/30B waits a T1 interval (T1 is the L2 timer 20D guarding the HARQ operation for the data packet, T1<T) and during T1:

(d.3.1) If the ARQ receiver 20B/30B receives a HARQ failure notification from HARQ, the ARQ receiver 20B/30B generates an ARQ (e.g., L2) NACK;

(d.3.2) Else if the T1 time 20D/30D times out before recovering the expected PSN, the ARQ receiver 20B/30B generates an ARQ NACK;

(d.3.3) Else, the ARQ receiver 20B/30B generates an ARQ (e.g., L2) ACK;

(d.4) Else, the ARQ receiver 20B/30B follows (a).

It is noted, as described in (a)-(d), that if it is determined that a request of a retransmission of an ARQ data unit (e.g., RLC PDU) should be made (block 735=YES), then the request for retransmission is made in block 740. If it is determined that a request should not be made (block 735=NO), the method 700 ends in block 745.

The operation in (d2), proactively requesting a necessary ARQ (e.g., L2) retransmission before the T timer 20C/30C timeout, and the operation in (d.3), helping to recover the packet after T timeout, avoids redundancy of the HARQ and ARQ and therefore improves the efficiency of network resource utilization.

It can be noted that the exemplary embodiments of this invention may be even more effective if the scheduling period is made much larger than T and T1. The scheduling period refers to the period that the current allocated resources to the user are valid and the user is allowed to transmit data constrained to the currently allocated resources.

E-UTRAN HARQ functionality may include HARQ error detection and recovery mechanisms. E-UTRAN HARQ assisted ARQ aims at significant enhancements in both reducing complexity and improving efficiency in terms of L2 throughput-delay performance while keeping robustness of the ARQ comparable with that used in UTRAN.

The ARQ level retransmissions can normally be based upon Local NACK indicated by the HARQ level at the transmitter side. Local NACK is generated whenever the HARQ transmitter gives up a particular HARQ process being used for transmitting a given TB, e.g. the maximum number of retransmissions are reached and no ACK is received.

Normal ARQ operation with status reporting is required for E-UTRAN ARQ to recover HARQ residual errors.

In case no further features such as aforementioned receiver-originated HARQ error detection and reporting are adopted, ARQ status reporting should utilize event-triggered reporting effectively to keep protocol overhead as low as possible. For example, the status report is sent only when the receiver performs reordering and detects a missing sequence number (SN) (e.g., PSN) segment. Thus, normally utmost one status report is sent per a reordering interval or window. In the meantime, the transmitter side can also rely on Local ACK and a suitable ARQ timer which is set in line with the reordering interval or window to manage related ARQ retransmission buffer. In addition, polling for status report on the last packet or infrequent high-priority traffic such as RRC signalling is needed as in UTRAN.

Because the delay associated with HARQ functionality is often much less than the delay associated with ARQ functionality involved in transfer of a given packet, retransmission schemes that rely as little as possible on the ARQ tend to provide, overall, shorter round trip time (RTT) and better packet delay. This motivates the introduction and usage of receiver-originated HARQ error detection and reporting as follows.

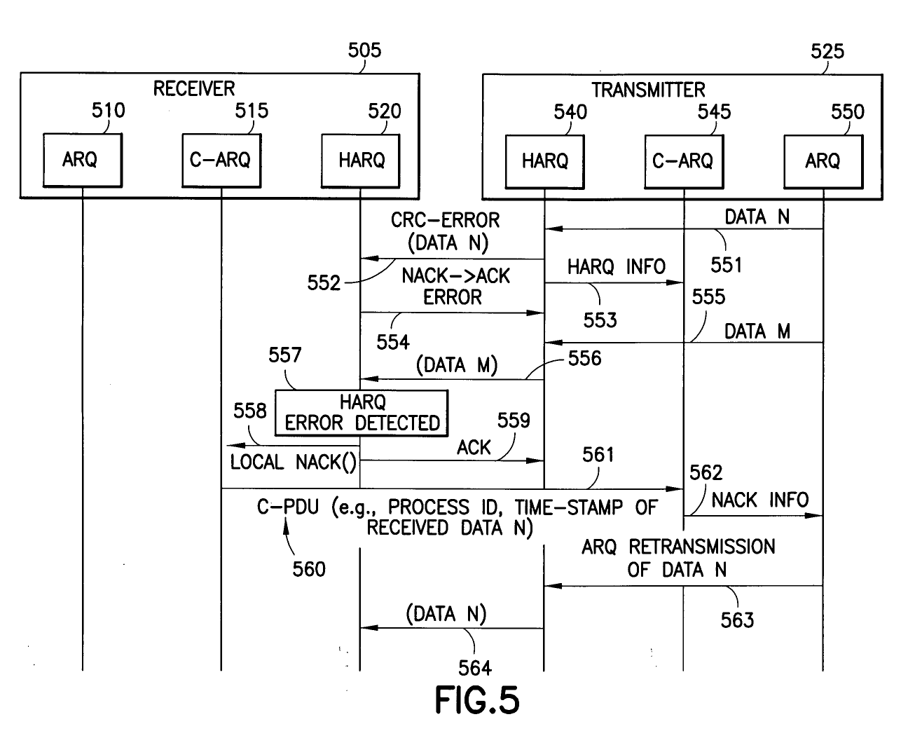

A mechanism behind the receiver-originated HARQ error detection and reporting is shown in FIG. 5. FIG. 5 shows a communication diagram between a transmitter 505 and a receiver 525. The receiver 505 has an ARQ transceiver 510, a C-ARQ transceiver 515, and a HARQ transceiver 520. The transmitter 525 has a HARQ transceiver 540, a C-ARQ transceiver 545, and an ARQ transceiver 550. The entities denoted as C-ARQ are considered as a common ARQ control entity inside MAC. The C-ARQ 515/545 are responsible for generating the HARQ error indication in form of a MAC control-type PDU (C-PDU 560) in the transceiver 515 and interpreting the MAC control-type PDU (C-PDU 560) in the transmitter 525. The transceiver-side C-ARQ 545 then forwards the NACK to each corresponding ARQ transceiver 550. This C-ARQ 515/545, however, is introduced for modeling purposes and would likely be implemented as part of an L2 controller (e.g., controller 20E/40B). The ARQ transceiver 550 transmits Data N to the HARQ transceiver 540 (551). The HARQ transceiver 540 transmits the Data N and a CRC error occurs (552).

The HARQ transceiver 540 communicates HARQ information (info) to the C-ARQ transceiver 545 (553). The HARQ transceiver 520 determines that an error occurs and sends a request for retransmission via a NACK (554). It is assumed as an example that the HARQ transceiver 540 at the transmitter side misunderstand that NACK as an ACK, resulting in a false positive ACK (in other words, the HARQ transceiver 540 misinterprets the NACK in 554 as an ACK). In the meantime, the ARQ transceiver 550 sends Data M to the HARQ transceiver 540 (555), which sends the Data M to the HARQ transceiver 520 (556). The HARQ transceiver 520 sends an ACK (559) corresponding to the Data M.

The receiver 505 (e.g., the HARQ transceiver 520) upon detecting a HARQ error of a NACK→ACK misinterpretation nature (557) generates a local NACK (558). The C-ARQ transceiver 515 then generates (561) a HARQ error indication 560 and sends (561) the HARQ error indication back to the transmitter 525 (e.g., as soon as possible). The HARQ error indication 560 includes information related to the lost data, for example, the process ID and the time-stamp associated with the instant when the new data indicator of the relevant TB was first received. The process ID information can be omitted in the case of synchronous HARQ as the process ID information is implicitly specified with a system frame number (SFN) in which the transport block is received. The time-stamp can be associated with other tracking time instant in specified HARQ operation as well. The HARQ error indication 560 is received by the C-ARQ transceiver 545, which generates (562) NACK information and communicates (562) this to the ARQ transceiver 550. The ARQ transceiver 550 then communicates (563) an ARQ retransmission message to the HARQ transceiver 540, which then retransmits (564) the Data N. It is also noted that the ARQ transceiver 550 can communicate (563) the Data N again to cause the Data N to be retransmitted.

FIG. 5 proposes that HARQ error indication is sent in form of a MAC C-PDU, not piggybacked in a MAC PDU. Using C-PDU ensures adequate reliability in sending the control message and also simplicity in processing the message.

The following points should also be noted.

With regard to the HARQ success/failure indication to the ARQ at the transmitter and/or receiver, the success indication in the transmitter side may be removed when used with the receiver procedure in accordance with the exemplary embodiments of this invention. This is useful for a practical implementation as it, e.g., reduces the amount of signaling over the L1/L2 interface 24 or the MAC/RLC interface 34.

The use of the exemplary embodiments of this invention also provide a single comprehensive implementation of an ARQ scheme by using the transmitter side (d) operations and the receiver side (d) operations. The use of the transmitter side (d) operations enhances the speed of the retransmission because the transmitter side can trigger the retransmission without waiting for an ARQ polling mechanism. The receiver side (d) operations beneficially aid in recovering from a HARQ NACK→ACK flipping error. Hence, the HARQ error condition can be avoided within this combined scheme well.

The use of the exemplary embodiments of this invention also provide for reducing unnecessary retransmissions caused by the HARQ ACK→NACK flipping error. According to experience with HSDPA, the order of the HARQ ACK→NACK flipping error is about 10⁻³. Therefore, the overhead caused by the unnecessary retransmission is less than 1%. On the other hand, the high cost HARQ NACK→ACK flipping error can be avoided by the exemplary embodiments of the receiver process as described above.

The use of the exemplary embodiments of this invention provide as one non-limiting advantage, as compared to the use of only the HARQ scheme or MAC HARQ scheme, a reduced complexity ARQ implementation. For this purpose, the CRC for the ARQ can be eliminated for achieving lower processing overhead, and the polling scheme may be used for a lower signaling load. These two factors tend to generally increase the retransmission delay. The use of the exemplary embodiments of this invention thus shortens the overall delay, and also provides the recovery mechanism from the HARQ NACK→ACK flipping error condition.

Further, the use of the exemplary embodiments of this invention does not require any additional signaling field for the ARQ (if the CRC is not used).

Further, the ARQ retransmission becomes faster, and more accurate (from the transmitter side). For example, the transmitter process (operation d.2.3) can maintain the ARQ (e.g., L2) retransmission delay within T1 from the time of the HARQ (e.g., L1) failure notification. This is generally much faster than the use of an ARQ polling scheme. Further, and even if the CRC is implemented in ARQ, in addition to the CRC for HARQ, the advantages obtained in the transmitter side process discussed above remain valid.

A still further advantage that is realized by the use of the exemplary embodiments of this invention is that the ARQ retransmission becomes faster, and more accurate (from the receiver side). For example, the receiver process (operations (c) or (d.2)) can reduce the time needed to send the ARQ NACK, as compared to the use of a polling mechanism. Further, the receiver process can recover a drawback of the transmitter process. That is, since the transmitter process cannot detect the HARQ NACK→ACK flipping error, the receiver process (operations (c) or (d.2)) can ensure that the necessary ARQ retransmission occurs.

As was noted above, the various embodiments of this invention may be implemented in hardware such as special purpose circuits or logic, software, or any combination thereof. For example, some aspects may be implemented in hardware, while other aspects may be implemented in software (e.g., firmware) which may be executed by a controller, microprocessor or other digital processing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware (e.g., special purpose circuits, logic, general purpose hardware or controllers, or other digital processing devices), software, (e.g., firmware), or some combination thereof.

It should also be noted that the exemplary embodiments of the inventions may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
receiving over a wireless link at least one transport block;
determining from the at least one transport block a first data unit, wherein a portion but not all of the first data unit includes a second data unit;
determining information corresponding to acknowledgement status of the first data unit;
determining, based at least on the information, whether a request should be performed requesting retransmission of the second data unit; and
performing the request in response to a determination that the request should be performed.

2. The method of claim 1, wherein:
determining information corresponding to acknowledgement status of the first data unit further comprises determining the information using at least one hybrid automatic repeat request technique performed on the first data unit; and
determining whether a request should be performed requesting retransmission of the second data unit further comprises determining whether the request should be performed using at least the information and at least one automatic repeat request technique performed on the second data unit.

3. The method of claim 1, wherein determining, based at least on the information, whether a request should be performed further comprises determining, based on the information, a sequence number corresponding to the second data unit.

4. The method of claim 1, wherein the information includes one of the following: an indication that at least one negative acknowledgement or at least one positive acknowledgement should be made; an indication that at least one negative acknowledgement or at least one positive acknowledgement was made; an indication that nothing is received instead of an expected positive acknowledgement or negative acknowledgement; an indication of a retransmission timeout; or an indication that a number of retransmissions of the first data unit exceeds a maximum allowed value that corresponds to the second data unit.

5. The method of claim 1, wherein determining whether a request should be made further includes determining whether the request should be made based at least on the information and on acknowledgement status of the second data unit.

6. The method of claim 1, wherein determining whether a request should be made further includes determining whether the request should be made based at least on the information and on at least one local timer that guards an event of receiving the second data unit.

7. The method of claim 1, wherein determining whether a request should be made further includes determining whether the request should be made based at least on the information, based on acknowledgement status of the second data unit, and on at least one local timer that guards an event of receiving the second data unit.

8. The method of claim 1, further comprising transmitting an acknowledged mode status report corresponding to acknowledgement status of at least the second data unit.

9. The method of claim 1, wherein the first data unit is a medium access control (MAC) protocol data unit (PDU) and wherein the second data unit is a radio link control (RLC) PDU.

10. The method of claim 9, further comprising determining the second data unit based on mapping from one of a transmission sequence number in the MAC PDU, a hybrid automatic repeat request process identity, or a dispatching timestamp to a packet sequence number in the RLC PDU.

11. The method of claim 1, wherein determining information corresponding to at least one first request for retransmission of the first data unit further comprises:
detecting at least one error corresponding to the first data unit; and
generating a local negative acknowledgement message.

12. The method of claim 11, wherein performing the request further comprises, in response to the local negative acknowledgement message, transmitting an hybrid automatic repeat request (HARQ) error indication using a medium access control (MAC) control-type protocol data unit (C-PDU), the HARQ error indication indicating that at least one HARQ error of a NACK→ACK misinterpretation nature corresponding to the transmitted first data unit occurred at a transmitter.

13. The method of claim 12, wherein the MAC C-PDU comprises an identification of the first data unit.

14. An apparatus comprising:
a first receiver configured to receive over a wireless link at least one transport block, the first receiver configured to determine from the at least one transport block a first data unit, wherein a portion but not all of the first data unit includes a second data unit; and
a second receiver coupled to the first receiver, the second receiver configured to determine, based at least on the information, whether a request should be performed requesting retransmission of the second data unit, the second receiver further configured to perform the request in response to a determination that the request should be performed.

15. The apparatus of claim 14, wherein one or both of the first and second receivers are implemented as part of an integrated circuit.

16. The apparatus of claim 14, wherein the first receiver includes a hybrid automatic request (ARQ) receiver, wherein the second receiver comprises a common ARQ control entity, wherein the hybrid ARQ receiver is configured communicate a local negative acknowledgement message to the common ARQ control entity, and wherein the common ARQ control entity, in response to the local negative acknowledgement message, is configured to transmit a hybrid automatic repeat request (HARQ) error indication using a medium access control (MAC) control-type protocol data unit (C-PDU), the HARQ error indication indicating that at least one HARQ error of a NACK→ACK misinterpretation nature corresponding to the transmitted first data unit occurred at a transmitter.

17. A computer program product tangibly embodying a program of machine-readable instructions executable by a digital processing apparatus to perform operations comprising:
receiving over a wireless link at least one transport block;
determining from the at least one transport block a first data unit, wherein a portion but not all of the first data unit includes a second data unit;
determining information corresponding to acknowledgement status of the first data unit;
determining, based at least on the information, whether a request should be performed requesting retransmission of the second data unit; and
performing the request in response to a determination that the request should be performed.

18. The computer program product of claim 17, wherein:
determining information corresponding to acknowledgement status of the first data unit further comprises determining the information using at least one hybrid automatic repeat request technique performed on the first data unit; and
determining whether a request should be performed requesting retransmission of the second data unit further comprises determining whether the request should be performed using at least the information and at least one automatic repeat request technique performed on the second data unit.

19. A method comprising:
determining information corresponding to acknowledgement status of a previously transmitted data unit that was transmitted over a wireless link using a transport block, wherein a portion but not all of the previously transmitted data unit includes a second data unit;
determining, based at least on the information, whether retransmission of the second data unit should occur; and
performing the retransmission of the second data unit in response to a determination that the retransmission should be performed.

20. The method of claim 19, wherein performing the retransmission of the second data unit further comprises creating at least one third data unit including the second data unit and transmitting over the wireless link the at least one third data unit using at least one additional transport block.

21. The method of claim 19, wherein determining, based at least on the information, whether retransmission of the second data unit should occur further comprises determining, based on the information, a sequence number corresponding to the second data unit.

22. The method of claim 19, wherein the information includes one of the following: an indication that at least one negative acknowledgement or at least one positive acknowledgement should be made; an indication that at least one negative acknowledgement or at least one positive acknowledgement was made.

23. The method of claim 19, wherein determining whether retransmission of the second data unit should occur further includes determining whether retransmission of the second data unit should occur based at least on the information and on acknowledgement status of the second data unit.

24. The method of claim 23, further comprising receiving an acknowledged mode status report corresponding to the second data unit and determining the acknowledgement status of the second data unit based on the acknowledged mode status report.

25. The method of claim 23, further comprising receiving a hybrid automatic repeat request (HARQ) error indication using a medium access control (MAC) control-type protocol data unit (C-PDU), wherein the HARQ error indication indicates that at least one HARQ error of a NACK→ACK misinterpretation nature corresponding to the previously transmitted data unit occurred at a transmitter, and determining acknowledgement status of the second data unit based on the HARQ error indication.

26. The method of claim 25, wherein the HARQ error indication comprises an identification of the previously transmitted data unit.

27. The method of claim 19, wherein determining whether retransmission of the second data unit should occur further includes determining whether retransmission of the second data unit should occur based at least on the information and on at least one local timer that guards an event of transmitting the second data unit.

28. The method of claim 19, wherein determining whether retransmission of the second data unit should occur further includes determining whether retransmission of the second data unit should occur based at least on the information, on acknowledgement status of the second data unit, and on at least one local timer that guards an event of transmitting the second data unit.

29. The method of claim 19, wherein the previously transmitted data unit is a medium access control (MAC) protocol data unit (PDU) and wherein the second data unit is a radio link control (RLC) PDU.

30. The method of claim 29, further comprising determining the second data unit based on mapping from one of a transmission sequence number in the MAC PDU, a hybrid automatic repeat request process identity, or a dispatching timestamp to a packet sequence number in the RLC PDU.

31. An apparatus comprising:
a first transmitter configured to determine information corresponding to acknowledgement status of a previously transmitted data unit that was transmitted over a wireless link using a transport block, wherein a portion but not all of the previously transmitted data unit includes a second data unit;
a second transmitter coupled to the first transmitter, the second transmitter configured to determine, based at least on the information, whether retransmission of the second data unit should occur, the second transmitter additionally configured to perform the retransmission of the second data unit in response to a determination that the retransmission should be performed.

32. The apparatus of claim 31, wherein one or both of the first and second transmitters are implemented as part of an integrated circuit.

33. The apparatus of claim 31, wherein:
the first transmitter comprises a common automatic repeat request (ARQ) control entity;
the second transmitter comprises an ARQ transmitter;
the common ARQ control entity is configured to receive a hybrid automatic repeat request (HARQ) error indication using a medium access control (MAC) control-type protocol data unit (C-PDU), wherein the HARQ error indication indicates that at least one HARQ error of a NACK→ACK misinterpretation nature corresponding to the previously transmitted data unit occurred at a transmitter, and wherein the common ARQ control entity is configured to determine a negative acknowledgement message based on the HARQ error indication and to communicate the negative acknowledgement message to the ARQ transmitter;
the ARQ transmitter is configured to perform the retransmission of the second data unit based on the negative acknowledgement message.

34. A computer program product tangibly embodying a program of machine-readable instructions executable by a digital processing apparatus to perform operations comprising:
determining information corresponding to acknowledgement status of a previously transmitted data unit that was transmitted over a wireless link using a transport block, wherein a portion but not all of the previously transmitted data unit includes a second data unit;
determining, based at least on the information, whether retransmission of the second data unit should occur; and
performing the retransmission of the second data unit in response to a determination that the retransmission should be performed.

35. The computer program product of claim 34, wherein performing the retransmission of the second data unit further comprises creating at least one third data unit including the second data unit and transmitting over the wireless link the at least one third data unit using at least one additional transport block.

36. The computer program product of claim 34, wherein the information includes one of the following: an indication that at least one negative acknowledgement or at least one positive acknowledgement should be made; an indication that at least one negative acknowledgement or at least one positive acknowledgement was made; an indication that nothing is received instead of an expected positive acknowledgement or negative acknowledgement; an indication of a retransmission timeout; or an indication that a number of retransmissions of the previously transmitted data unit exceeds a maximum allowed value that corresponds to the second data unit.
